(19) United States
(12) Patent Application Publication
(10) Pub. No.: US 2003/0065699 A1
(43) Pub. Date: Apr. 3, 2003

(54) Split multiplier for efficient mixed-precision DSP

(75) Inventor: Geoffrey Burns, Ridgefield, CT (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/968,120

(22) Filed: Oct. 1, 2001

(51) Int. Cl. G06F 7/52

(52) U.S. Cl. 708/625

(57) ABSTRACT

A method and architecture with which to achieve efficient sub-word parallelism for multiplication resources is presented. In a preferred embodiment, a dual two's complement multiplier is presented, such that an n bit operand B can be split, and each portion of the operand B multiplied with another operand A in parallel. The intermediate products are combined in an adder with a compensation vector to correct any false negative sign on the two's complement sub-product from the multiplier handling the least significant, or lower, p bits of the split operand B, or B_{[p-1:0]}, where p=n/2. The compensation vector C is derived from the A and B operands using a simple circuit.

The technique is easily extendible to 3 or more parallel multipliers, over which an n bit operand D can be split and multiplied with operand A in parallel. The compensation vector C′ is similarly derived from the D and A operands in an analogous manner to the dual two's complement multiplier embodiment.

### TECHNICAL FIELD

The present invention relates to digital signal processing (“DSP”), and in particular to optimization of multiplication operations in digital signal processing ASIC implementations.

### BACKGROUND OF THE INVENTION

Programmable digital signal processing systems are known to be both area and power inefficient for algorithm implementations that mix fixed point precision of signal processing variables. This inefficiency results from the need to have all the hardware that is to be shared between the various operational precisions to accommodate the maximum precision. In other words, the maximum necessary precision must be supported by the shared hardware. Thus, inefficiencies result when this hardware is used by operations requiring a lesser precision.

In fixed ASIC implementations, precision is often minimized to improve hardware efficiency. A familiar example is the decision feedback equalizer, used in Vestigial Side band for digital terrestrial television reception(“ATSC 8-VSB”) applications, where the data operands are composed of 4 bit decision symbols. For the feed-forward portion of the equalizer, the full 12-bit soft symbol precisions are used. The feed-forward equalizer is typically composed of 64 forward taps with 16-bit coefficients, while the feedback equalizer is typically composed of 128 taps with 16-bit coefficients. Thus, when optimized in an ASIC's hardware, the feedback calculations would require 128 4×16 multiplications, and the feed-forward calculations 64 12×16 multiplications. They would thus be mapped to different multipliers. However, if the equalizer is mapped to a hardware-shared programmable system, this would require all operations, including the 128 4×16 multiplications, to be mapped to the same 12×16 multipliers, because that's the only multiplier available. This latter case would thus introduce 128 mapping instances that are three-fold larger than the fixed ASIC counterpart, effectively wasting two thirds of the available hardware during each feedback multiplication operation.

Theoretically, to remedy this inefficiency, the inefficient mapping can be somewhat mitigated with sub-word parallelism in arithmetic and storage resources. Subword parallelism allows for multiple operands to be fetched and operated upon in parallel, and relies upon parallel arithmetic resources to be available. For example, if the shared hardware is designed to implement 12×16 multiplications, it can easily be adapted to also implement three parallel 4×16 multiplications simultaneously. Or, for a full 12×16 multiplication, thus involving a full precision 12 bit word, the word can be split over three 4×16 multipliers and the intermediate results combined. However, in this instance, if the word is to be combined in a full precision operation, then the arithmetic resources should also be combinable to a full precision operation. While splitting and combining the precision of resources is straightforward for memory and simple units as adders, it is difficult for two's complement multipliers. Standard two's complement multipliers, such as e.g., Booth or Baugh-Wooley, will interpret a nonzero bit in the leftmost (MSB), or sign, position to signify a negative number. Distribution of a wide operand among two or three two's complement multipliers, attempted as depicted in the structure of FIG. 2, will thus simply not produce the correct product.

Thus, what is needed in the art is a means to efficiently implement two's complement multiplications of varying precisions using shared hardware.

What is further needed is a means to achieve correct product results when mapping large operands over multiple parallel smaller multipliers in two's complement multiplication.

### SUMMARY OF THE INVENTION

The present invention seeks to improve upon the above described deficiencies of the prior art by presenting a method and architecture for realizing split two's complement multiplications. The invention thus provides a method and architecture with which to achieve efficient sub-word parallelism for multiplication resources.

In a preferred embodiment, a dual two's complement multiplier is presented, such that an n bit operand B can be split, and each portion of the operand B multiplied with another operand A in parallel. The intermediate products are combined in an adder with a compensation vector to correct any false negative sign on the two's complement sub-product from the multiplier handling the least significant, or lower, p bits of the split operand B, or B_{[p,1:0]}, where p=n/2. The compensation vector C is derived from the A and B operands using a simple circuit.

The technique of the invention is easily extendible to 3 or more parallel multipliers, over which n bit operands D can be split and multiplied with operand A in parallel. The compensation vector C′ is similarly derived from the D and A operands in an analogous manner to the dual two's complement multiplier embodiment.

### BRIEF DESCRIPTION OF THE DRAWINGS

FIG. 1 depicts two m by p two's complement multipliers operating in parallel and sharing an operand;

FIG. 2 depicts distributing an operand over two m by p two's complement multipliers and combining the sub-products in an output adder;

FIG. 3 shows an improvement of the conventional structure of FIG. 2 according to the preferred embodiment of the present invention;

FIG. 4 depicts the system of FIG. 3 in more detail; and

FIG. 5 depicts an example circuit to obtain the compensation vector according to the present invention.

### DETAILED DESCRIPTION OF THE PREFERRED EMBODIMENTS

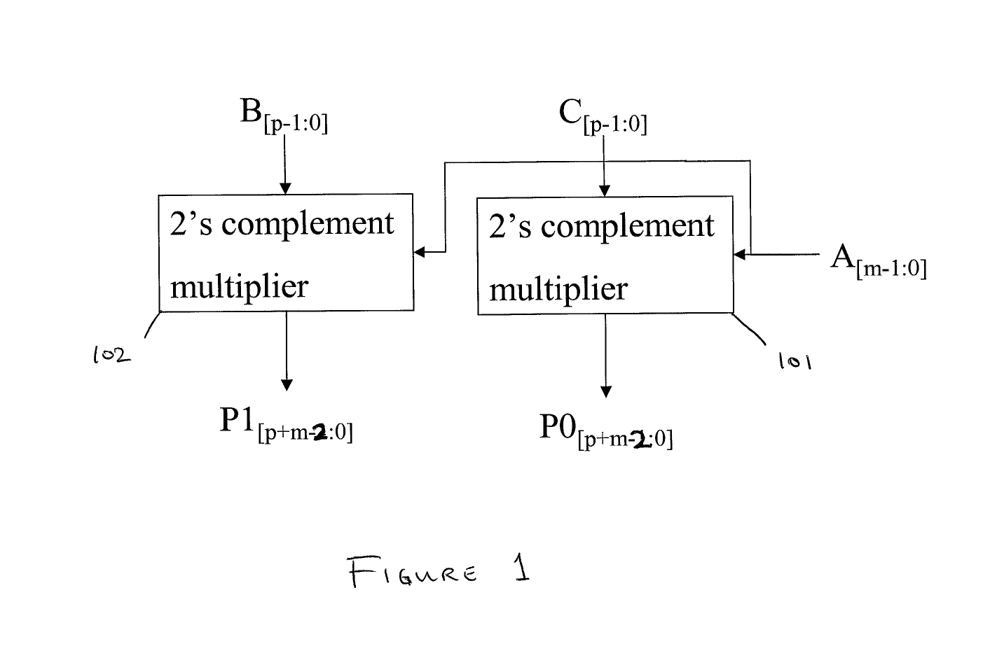

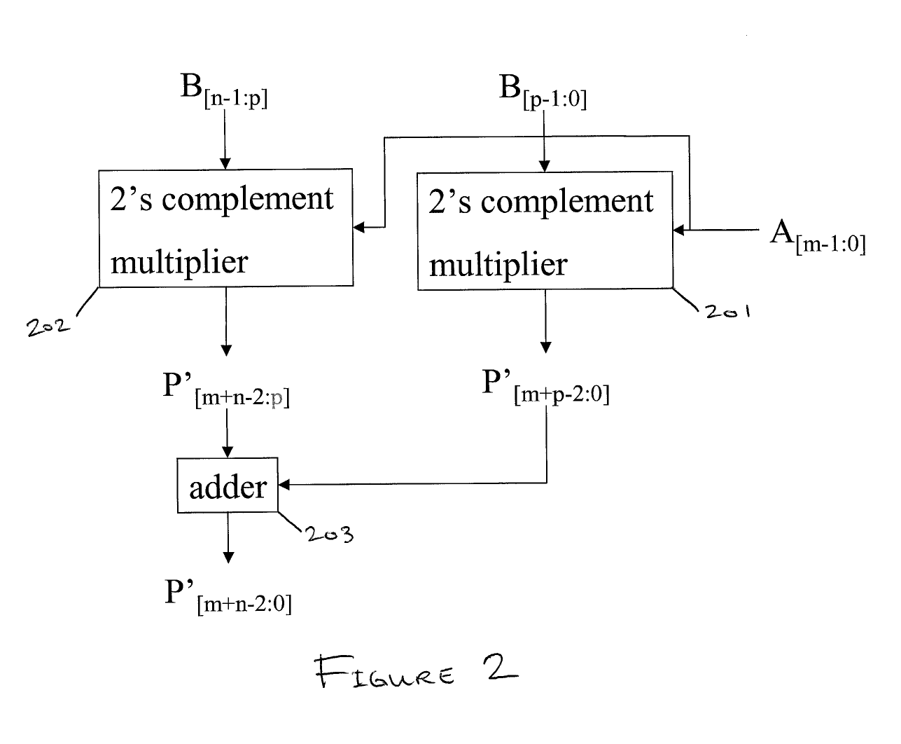

This invention discusses the means to realize split twos complement multipliers, in order to provide efficient sub-word parallelism for multiplication resources. As an example, a dual multiplier configuration is desired that can realize two parallel reduced precision operations as illustrated in FIG. 1. It is desirable for these same multipliers to support one full precision operation, such as that illustrated in FIG. 2.

For the VSB DFE example discussed above, three 4×16 multiplier arrays can provide either three simultaneous multiplications, or else one 12×16 multiplication. This split multiplier is thus an important tool to realize area and power-efficient hardware-shared programmable resources.

The realization of a split multiplier will be next illustrated with the case of two separate two's complement multipliers. With reference to FIG. 1, two m by p two's complement multipliers 101 and 102 realize parallel multiplications with a single shared m-bit coefficient A, thus multiplying A by both B and C in parallel, generating product P1 as the result of B×A, and product PO as the result of C×A. Such multiplication would be used for two lesser precision multiplications in the scenario discussed above.

FIG. 2 illustrates the case of a higher precision multiplication split across two multipliers. FIG. 2 depicts an attempt to distribute a single n-bit operand B across the same two m×p multipliers 201 and 202, and to thus form the product by combining the sub-products in an output adder 203. In the depicted case the correct product will not be achieved because the p−1th bit in operand B will be interpreted as the two's complement sign bit in the lower order multiplier 201.

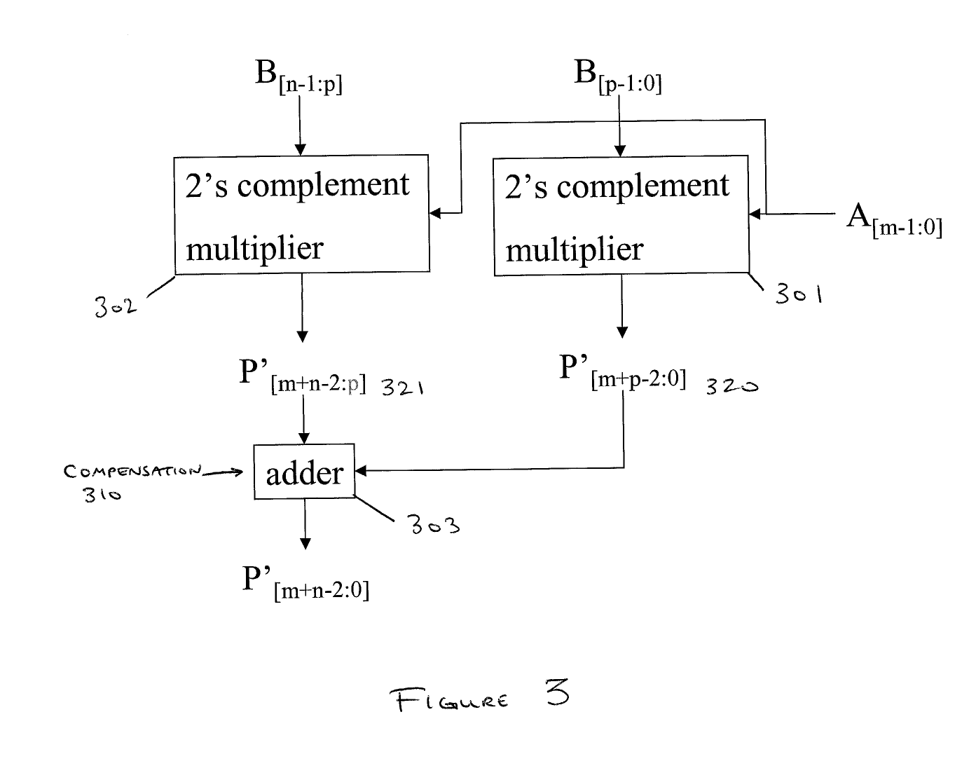

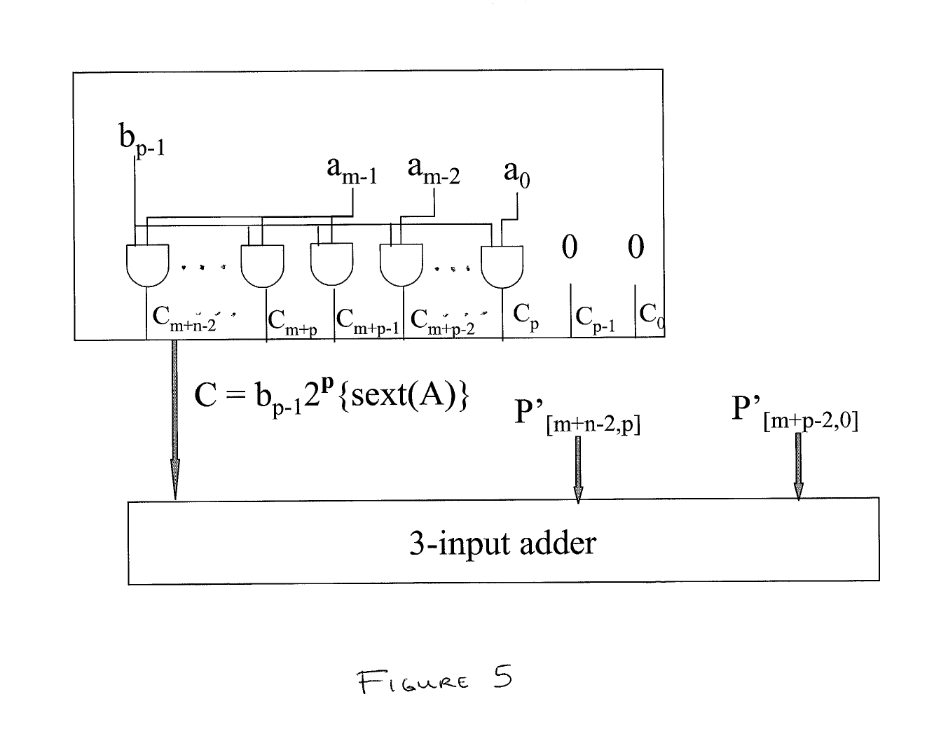

The correct method to split operand B over the two multipliers is depicted in FIG. 3. In FIG. 3 the correct result is achieved by injecting a compensation vector 310, along with the two multiplication sub-products 320 and 321, into the final product addition. The compensation vector is derived from the A and B operands using a simple circuit. An example of such circuit is depicted in FIG. 5. The analytic relationship between the A and B operands and the compensation vector C will be derived below for the two and three multiplier cases, and can easily be extended therefrom to as many multipliers as desired.

The compensation vector can be added to the product by (i) an additional adder following the sub-product combination adder (not shown); (ii) an additional port in the sub-product combination adder 303 (the shown embodiment in FIG. 3); or (iii) an additional row in each of the 2's complement multiplication panels (not shown).

Furthermore, the split multiplier can be realized as two separate two's complement multiplier panels with a single split adder to form the final products. By utilizing any of these design options, no significant gate delay penalty need be incurred by the split multiplier architecture herein presented.

For the three to one multiplier case desired for the VSB DFE, a similar derivation as follows for the two multiplier case can determine the compensation vector required to merge the three two's complement multipliers into one combined multiplier. For illustration, the derivation of the compensation vector for two separate multipliers merged into one is next described.

An operand is expressed as follows in two's complement format:

$$A = - {a}_{m - 1} {2}^{m - 1} + {\sum }_{i = 0}^{m - i} {a}_{i} {2}^{i} \qquad Equation 1$$

Note the negative value for the most significant bit (sign).

The Product of m by n multiplicands aₘ and bₙ is thus expressed as follows:

$$\begin{matrix}{P}_{a b} = [ - {a}_{m - 1} {2}^{m - 1} + {\sum }_{i = 0}^{m - 2} {a}_{i} {2}^{i} ] \times [ - {b}_{n - 1} {2}^{n - 1} + {\sum }_{j = 0}^{n - 2} {b}_{j} {2}^{j} ] \\ = {a}_{m - 1} {b}_{n - 1} {2}^{m + n - 2} - {a}_{m - 1} {\sum }_{j = 0}^{n - 2} {b}_{j} {2}^{m + j - 1} - \\ {b}_{n - 1} {\sum }_{i = 0}^{m - 2} {a}_{i} {2}^{n + i - 1} + {\sum }_{i = 0}^{m - 2} {\sum }_{j = 0}^{n - 2} {a}_{i} {b}_{j} {2}^{i + j} \\ = ( 1 ) + ( 2 ) + ( 3 ) + ( 4 )\end{matrix} \qquad Equation 2$$

Interpretation of the split n-bit multiplicand, B, by the dual m by p two's complement multipliers in the lower order multiplier interprets the most significant bit of the segment as a sign, as follows:

$$B = - {b}_{n - 1} {2}^{n - 1} + {\sum }_{j = p}^{n - 2} {b}_{j} {2}^{j} + {\sum }_{k = 0}^{p - 1} {b}_{k} {2}^{k} ⇒ - {b}_{n - 1} {2}^{n - 1} + {\sum }_{j = p}^{n - 2} {b}_{j} {2}^{j} - {b}_{p - 1} {2}^{p - 1} + {\sum }_{k = 0}^{p - 2} {b}_{k} {2}^{k} \qquad Equation 3$$

Substituting Error! Reference source not found. into Error! Reference source not found. yields Equation 4, as follows:

$$\begin{matrix}{P}_{a b}^{′} = [ - {a}_{m - 1} {2}^{m - 1} + {\sum }_{i = 0}^{m - 2} {a}_{i} {2}^{i} ] \times [ - {b}_{n - 1} {2}^{n - 1} + \\ {\sum }_{j = p}^{n - 2} {b}_{j} {2}^{j} - {b}_{p - 1} {2}^{p - 1} + {\sum }_{k = 0}^{p - 2} {b}_{k} {2}^{k} ] \\ = {a}_{m - 1} {b}_{n - 1} {2}^{m + n - 2} - {a}_{m - 1} \{ {\sum }_{j = p}^{n - 2} {b}_{j} {2}^{m + j - 1} - \\ {b}_{p - 1} {2}^{m + p - 2} + {\sum }_{j = 0}^{p - 2} {b}_{k} {2}^{m + j - 1} \} - \\ {b}_{n - 1} {\sum }_{i = 0}^{m - 2} {a}_{i} {2}^{n + i - 1} + {\sum }_{i = 0}^{m - 2} {\sum }_{j = p}^{n - 2} {a}_{i} {b}_{j} {2}^{i + j} + \\ {\sum }_{i = 0}^{m - 2} {\sum }_{j = 0}^{p - 2} {a}_{i} {b}_{j} {2}^{i + j} - {b}_{p - 1} {\sum }_{i = 0}^{m - 2} {a}_{i} {2}^{p + i - 1}\end{matrix} \qquad Equation 4$$

Comparing Error! Reference source not found. with Error! Reference source not found., finds the compensation term, as shown in Equation 5:

$$\begin{matrix}{P}_{a b}^{′} = ( 1 ) + ( 3 ) + ( 2 ) + 2 {a}_{m - 1} {b}_{p - 1} {2}^{m + p - 2} + \\ ( 4 ) - 2 {b}_{p - 1} {\sum }_{i = 0}^{m - 2} {a}_{i} {2}^{p + i - 1} \\ = {P}_{a b} + {a}_{m - 1} {b}_{p - 1} {2}^{m + p - 1} - {b}_{p - 1} {\sum }_{i = 0}^{m - 2} {a}_{i} {2}^{p + i} \\ = {P}_{a b} - c o m p e n s a t i o n\end{matrix} \qquad Equation 5$$

where compensation is given by Equation 6,

$$c o m p e ns a t i o n = {b}_{p - 1} [ - {a}_{m - 1} {2}^{m + p - 1} + {\sum }_{i = 0}^{m - 2} {a}_{i} {2}^{p + i} ] \qquad Equation 6$$

which is simply equal to zero, if the MSB of multiplicand B, bₚ₋₁, is equal to zero, or compensation=0 if bₚ₋₁=0.

Replacing the negative term in Error! Reference source not found. with an additive term yields

$$- {a}_{m - 1} {2}^{m + p - 1} = {a}_{m - 1} \{ ( {\sum }_{m + p}^{m + n - 2} {2}^{i} ) + 0 * {2}^{m + p - 1} + ( {\sum }_{0}^{m + p - 2} {2}^{i} ) + 1 \} = {a}_{m - 1} ( {\sum }_{m + p - 1}^{m + n - 2} {2}^{i} ) \qquad Equation 7$$

And finally, the compensation vector is the sign-extended A multiplicand, left-shifted by p, the sub-multiplier width, as shown in Equation 8. The compensation vector is only applied for nonzero false sign bₚ₋₁, Thus, a simple check must be done by the hardware for a nonzero bit in the p−1th position. If this bit is 1, then the compensation vector is added to the final adder.

$${P}_{a b} = {P}_{a b}^{′} + {b}_{p - 1} \{ {a}_{m - 1} {\sum }_{m + p - 1}^{m + n - 2} {2}^{i} + {\sum }_{0}^{m + p - 2} {a}_{i} {2}^{p + i} \} \qquad Equation 2$$

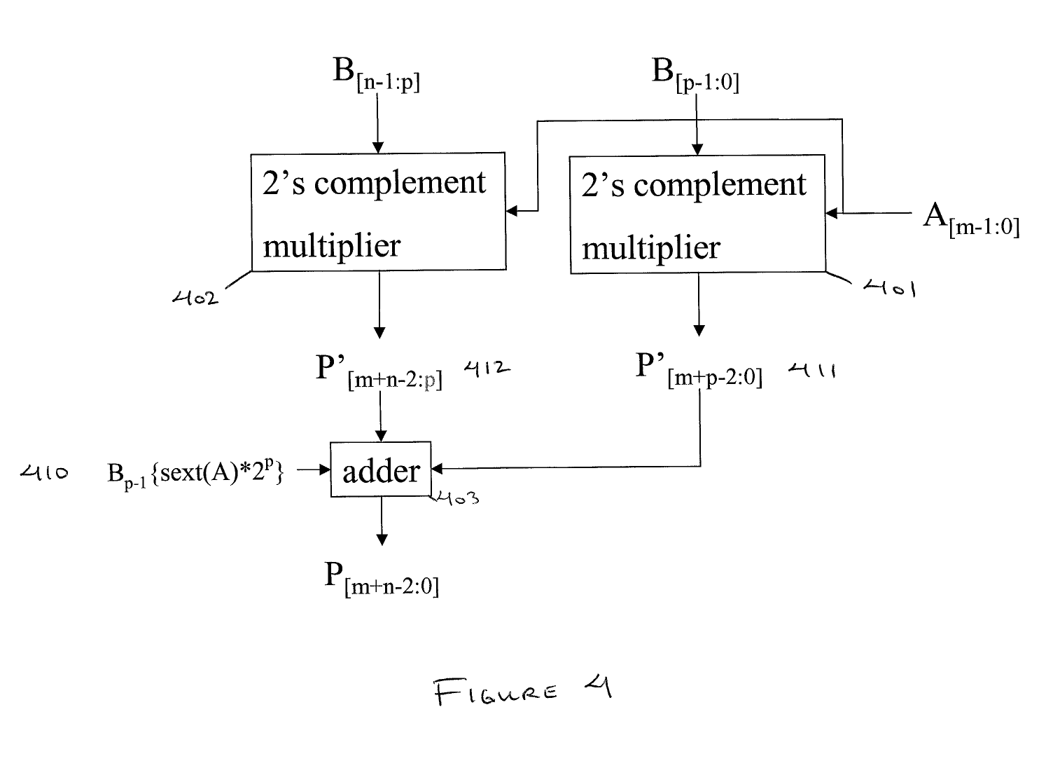

FIG. 4 thus depicts the complete two multiplier embodiment of the invention, showing, as before, the two multipliers 401 and 402, and the adder. Multiplican d B is split over the two multipliers 401 and 402, and the intermediate products 411 and 412 are added together, in the adder 403, with the compensation vector 410, yielding the correct product 450. The compensation vector is zero if the p−1th bit of multiplicand B is zero, as described above.

Next, for completeness, the compensation vector derivation for the three operand case is presented.

$$B = - {b}_{n - 1} {2}^{n - 1} + {\sum }_{j = p}^{n - 2} {b}_{j} {2}^{j} + {\sum }_{k = 0}^{p - 1} {b}_{k} {2}^{k} + {\sum }_{l = 0}^{q - 1} {b}_{l} {2}^{l} ⇒ - {b}_{n - 1} {2}^{n - 1} + {\sum }_{j = p}^{n - 2} {b}_{j} {2}^{j} - {b}_{p - 1} {2}^{p - 1} + {\sum }_{k = 0}^{p - 2} {b}_{k} {2}^{k} - {b}_{q - 1} {2}^{q - 1} + {\sum }_{l = 0}^{q - 2} {b}_{l} {2}^{l} \qquad Equation 9$$

In a similar manner to the 2-way split derived above, multiply Equation 1 above by Equation 9 to obtain the expanded product. Compare the 12 terms with the Equation for the consolidated multiplier (Equation 2) to obtain:

$$\begin{matrix}{P}_{a b}^{′} = ( 1 ) + ( 3 ) + ( 2 ) + 2 {a}_{m - 1} {b}_{p - 1} {2}^{m + p - 2} + \\ 2 {a}_{m - 1} {b}_{q - 1} {2}^{m + q - 2} + ( 4 ) - 2 {b}_{p - 1} {\sum }_{i = 0}^{m - 2} {a}_{i} {2}^{p + i - 1} - \\ 2 {b}_{q - 1} {\sum }_{i = 0}^{m - 2} {a}_{i} {2}^{q + i - 1} \\ = {P}_{a b} + {a}_{m - 1} {b}_{p - 1} {2}^{m + p - 1} - {b}_{p - 1} {\sum }_{i = 0}^{m - 2} {a}_{i} {2}^{p + i} + \\ {a}_{m - 1} {b}_{q - 1} {2}^{m + q - 1} - {b}_{q - 1} {\sum }_{i = 0}^{m - 2} {a}_{i} {2}^{q + i} \\ = {P}_{a b} - c o m p e ns a t i o n ( p ) - c o m p e ns a t i o n ( q )\end{matrix} \qquad Equation 10$$

Where for each compensation term

$$compensation ( x ) = {b}_{x - 1} [ - {a}_{m - 1} {2}^{m + x - 1} + {\sum }_{i = 0}^{m - 2} {a}_{i} {2}^{x + i} ] = {b}_{x - 1} \{ {a}_{m - 1} {\sum }_{m + x - 1}^{m + n - 2} {2}^{i} + {\sum }_{0}^{m + x - 2} {a}_{i} {2}^{x + i} \} = {b}_{x - 1} {2}^{x} s e x t ( A ) \qquad Equation 11$$

Generally speaking, to introduce a split in a 2's complement multiplier panel along either operand, we must add a correction term (Equation 11) to the addition of partial sums from each panel. The correction term is simply the multiplicand orthogonal to the split (operand not split), sign-extended, multiplied by the false sign in the split operand, then shifted such that the LSB of the correction is added to the partial sum introduced by the upper half of the panel. Such a split can be introduced repetitively along either operand, to render an arbitrary partitioning of a multiplier. Each split of an operand generates the need for one compensation vector to correct the final product.

In general, there is one compensation vector for each partition of the multiplier along one axis. E.g. if each multiplicand is split once, composing the multiplier from four panels, two compensation vectors are needed.

While the foregoing describes the preferred embodiment of the invention, it is understood by those of skill in the art that various modifications and variations may be utilized, such as, for example, extending the invention to split multiplicands over many multipliers, thus enabling multiplications at various levels of precision to be implemented over the same shared hardware. Additionally, the use of variations on the example methods of adding the compensation vector to the final adder can be easily implemented. Such modifications are intended to be covered by the following claims.

What is claimed:

1. A method of realizing two's complement multiplication utilizing subword parallelism, comprising:
splitting a first operand B amongst a plurality of multipliers and multiplying each of them with a second multiplicand A; and
adding intermediate products with compensation vectors to obtain the final product.

2. The method of claim 1, where the multipliers have equal width.

3. The method of claim 2, where the compensation vector is:
zero if no false sign bit is introduced in the MSB of a given piece of the split operand B; and
the sign extended second multiplicand A, left shifted by the width of the lower split multiplier.

4. The method of claim 1, where the compensation vector is added by one of the following:
an additional addition other than the intermediate product addition;
simultaneous with the intermediate product addition; or
simultaneous with the parallel multiplications.

5. The methods of any of claims 1-4 used to implement multiplications of varying precisions on the same shared hardware.

6. The method of claim 5, where the number of multipliers is either two or three.

7. An integrated circuit capable of implementing multiple precision two's complement multiplications, comprising:
two submultipliers;
an adder, and
a circuit to generate a compensation vector.

8. The circuit of claim 7, additionally comprising a circuit to test for nonzero sign bits in the MSB of a multiplicand of a submultiplier.

9. The circuit of claim 8, where the additional circuit controls the value of the compensation vector.

10. The circuit of any of claims 7-9, where the compensation vector is added via one of the following:
an additional adder other than the intermediate product adder;
an additional port in the intermediate product adder; or
an additional row in the two's complement multiplication panels.

11. An integrated circuit capable of implementing multiple precision two's complement multiplications, comprising:
N submultipliers;
an adder; and
circuitry to generate a compensation vector.

12. The circuit of claim 11, additionally comprising a circuit to test for nonzero sign bits in the MSB of one multiplicand of each submultiplier.

13. The circuit of claim 12, where the additional circuitry controls the value of the compensation vector.

14. The circuit of any of claims 11-13, where the compensation vector is added via one of the following:
an additional adder other than the intermediate product adder;
an additional port in the intermediate product adder; or
an additional row in the two's complement multiplication panels.

15. The circuit of claim 14, where there is one compensation vector for each partition of the multiplier along one axis.

16. The method of claim 5, where there is one compensation vector for each partition of the multiplier along one axis.
